(19) United States
(12) Patent Application Publication
(10) Pub. No.: US 2011/0007722 A1
(43) Pub. Date: Jan. 13, 2011

(54) Base Station Selection Method for a Wireless Communication System and Device Using the Same

(76) Inventors: Cheng-Hsuan Wu, Taipei City (TW); Yuan-Chin Wen, Taipei City (TW); Feng-Chi Wu, Nantou County (TW); Jiunn-Tsair Chen, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/637,756

(22) Filed: Dec. 15, 2009

(30) Foreign Application Priority Data
Jul. 9, 2009 (TW) 098123219

(51) Int. Cl. H04W 4/00; H04B 7/00

(52) U.S. Cl. 370/338; 455/500

(57) ABSTRACT

A base station selection method is disclosed. The wireless communication system includes a plurality of base stations with overlapped radio ranges and a plurality of wireless devices. The method includes steps of modeling the plurality of base stations as a plurality of variable nodes in a factor graph, modeling the plurality of wireless devices as a plurality of constraint nodes in the factor graph, and selecting a base station for transmission from the plurality of base stations based on the factor graph. Each variable node is defined as a frequency band state of a corresponding base station. Each constraint node is linked to the variable nodes corresponding to the base stations that include the corresponding wireless device in their radio ranges, and is defined as that the frequency band states of the base stations including the corresponding wireless device in their radio ranges can not be all turned off.

### BACKGROUND OF THE INVENTION

1. Field of the Invention

The present invention relates to a base station selection method for a wireless communication system, and more particularly to, a method and device of using a graphic interface to model an overlapping base station problem in a multicast scenario for selecting a base station for transmission.

2. Description of the Prior Art

In a wireless communication system, e.g. a wireless local area network (WLAN), if two or more base stations (unrelated with each other) have overlapped radio ranges and operate in the same frequency band, signals transmitted by a wireless device within a radio range of one base station may interfere with the one within a radio range of another base station. It is called an overlapping basic service sets (OBSS) problem in the WLAN field.

In a unicast scenario, a hidden terminal problem induced by the overlapped base stations can be solved by a Request To Send (RTS)/Clear To Send (CTS) mechanism. Through the RTS/CTS mechanism, the transmission terminal sends an RTS packet before transmitting data, and the reception terminal sends a CTS packet when receiving the RTS packet, to inform the transmission terminal that data transmission can start over and to inform other wireless devices that no data transmission is allowed in this period to avoid collision. However, the RTS/CTS mechanism can not be applied to a multicast scenario. Thus, in the multicast scenario, the base station overlapping problem conventionally is solved by assigning different frequency bands to the adjacent base stations with overlapped radio ranges. However, as complexity of the network topology increases, under a situation that the number of frequency bands available for each base station is limited, how to effectively assign the frequency bands to the base stations in the multicast scenario is still an open problem.

Besides, under the situation that the base stations have overlapped radio ranges, when intending to send multicast data to the wireless device within the overlapped radio ranges, the wireless communication system has to properly select the base station for transmission to avoid unnecessary data duplication. For example, please refer to FIG. 1, which illustrates that a wireless communication system 10 selects a base station in a multicast scenario under the base station overlapping problem. As shown in FIG. 1, assume that a wireless device STA1 is located within the overlapped radio range formed by the base stations BS1 and BS2, and is on multicast lists of both the base stations BS1 and BS2. When intending to send the multicast data to the wireless device STA1, the wireless communication system 10 must select a proper base station for transmission, the base station BS1 for example, to avoid transmission resource waste caused by unnecessary data duplication. However, the prior art does not teach how to effectively select the base station for transmission, to minimize unnecessary data duplication.

### SUMMARY OF THE INVENTION

It is therefore an objective of the present invention to provide a base station selection method and device for a wireless communication system.

The present invention discloses a base station selection method for a wireless communication system, the wireless communication system comprising a plurality of base stations with overlapped radio ranges and a plurality of wireless devices. The method comprises the steps of modeling the plurality of base stations as a plurality of variable nodes in a factor graph, each variable node having a variable defined as a frequency band state of the modeled base station, modeling the plurality of wireless devices as a plurality of constraint nodes in the factor graph, each constraint node linked to the variable nodes that the corresponding base stations have radio ranges covering the modeled wireless device, and having a constraint defined as that frequency band states of the base stations with the radio ranges covering the modeled wireless device cannot be all turned off, and selecting a base stations for transmission from the plurality of base stations based on the factor graph.

The present invention further discloses a wireless device for a wireless communication system. The wireless device is utilized for executing the base station selection method to select base stations for transmission over the wireless communication system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates that a wireless communication system selects abase station in a multicast scenario under a base station overlapping problem.

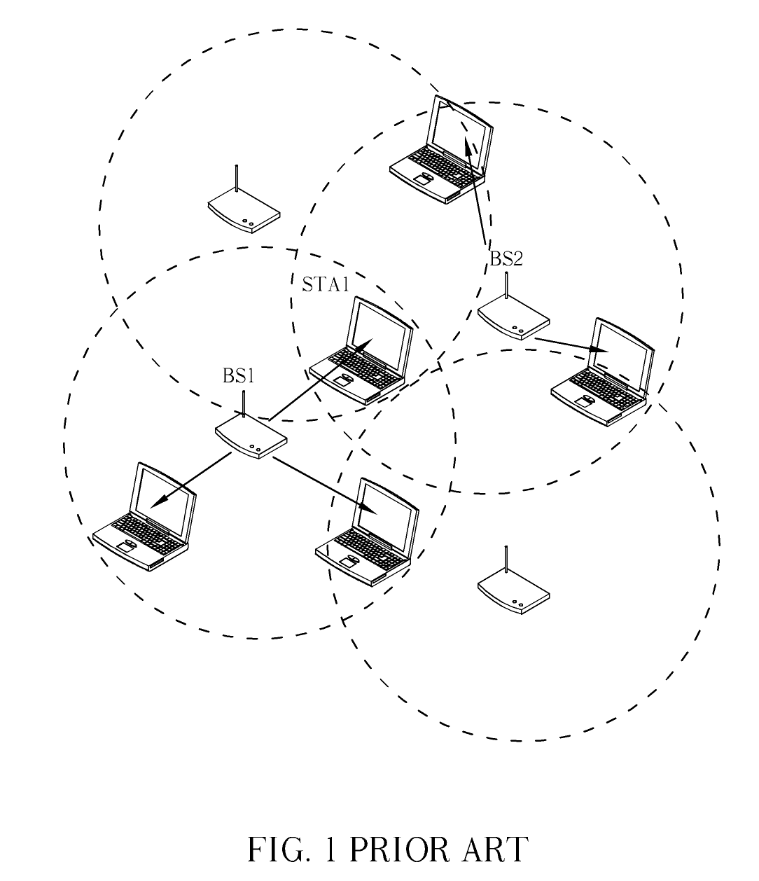

FIG. 2 is a schematic diagram of a factor graph.

FIG. 3 is a flowchart of a process according to an embodiment of the present invention.

FIG. 4 is a schematic diagram of a wireless communication system with a base station overlapping problem.

FIG. 5 illustrates a factor graph generated by modeling the network topology shown in FIG. 4 according to an embodiment of the present invention.

FIG. 6 illustrates a factor graph generated by modeling the network topology shown in FIG. 4 according to another embodiment of the present invention.

### DETAILED DESCRIPTION

By using the distributed property of the network, the present invention proposes to use a factor graph, which has a distributed computing property in nature, to model an overlapped base station problem in a multicast scenario for effectively selecting base stations on different network topologies, and improving disadvantages in the prior art.

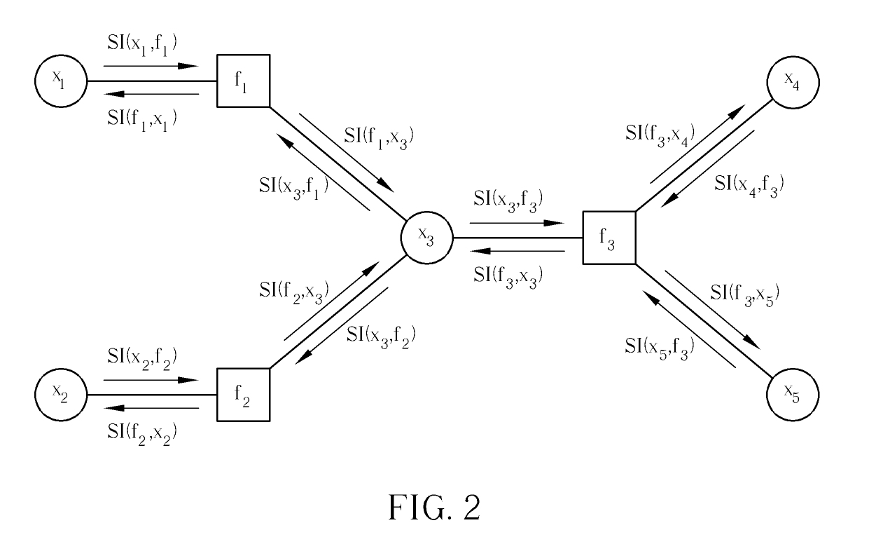

The factor graph adopts Sum-Product Algorithms to effectively process all kinds of coding in communication, signal processing and artificial intelligence in view of graph. First of all, please refer to FIG. 2, which is a schematic diagram of a factor graph. It is utilized for solving an equation, given by:

f(x₁,x₂,x₃,x₄,x₅)=f₁(x₁,x₃)·f₂(x₂,x₃)·f₃(x₃,x₄,x₅) (Eq.1)

As known from Eq.1, the function f represents a product of functions f1, f2 and f3. Meanwhile, the function f1 is merely associated with variables x1 and x3; the function f2 is merely associated with variables x2 and x3; the function f3 is merely associated with variables x3, x4 and x5. Factor graph is to deal with the relation between the variable and function in view of graph. Taking FIG. 2 as an example, each function is represented by a block, called constraint node or agent node, and the variables x1˜x5 are represented by a circle, called variable node. The connections between the constraint nodes and the variable nodes depend on the relation of the functions and the variables. For example, the function f1 is merely associated with the variables x1 and x3. The constraint node representing the function f1 is connected with only the variable nodes representing the variables x1 and x3. By the same token, factor graph can be illustrated as shown in FIG. 2. On the other hand, information transmitted between the constraint nodes and the variable nodes is soft information SI. Each SI is merely associated with the adjacent constraint nodes and variable nodes and can determine its content according to other related soft information. For example, the soft information SI(x3, f3) from the variable node x3 to the constraint node f3 can be represented by:

SI(x₃,f₃)=SI(f₁,x₃)·SI(f₂,x₃)

Accordingly, a result of f(x1, x2, x3, x4, x5) can be yielded as long as the number of times that the soft information is transmitted and processed are sufficient.

In addition to simplifying the complicated computations, since the relation between the functions and the variables are expressed in view of graph, the factor graph can be easily extended by determining the relation of new nodes and original nodes when intending to extend the computational constraint.

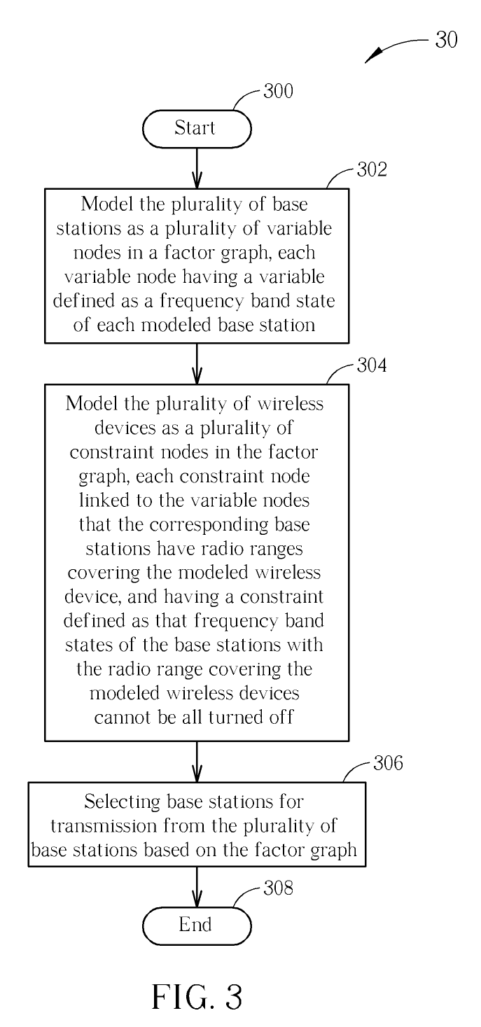

Please refer to FIG. 3, which is a flowchart of a process 30 according to an embodiment of the present invention. The process 30 is utilized for implementing a base station selection method for a wireless communication system. The wireless communication system, e.g. a wireless local area network (WLAN) includes a plurality of base stations with overlapped radio ranges and a plurality of wireless devices. The process 30 includes the following steps:

Step 300: Start.

Step 302: Model the plurality of base stations as a plurality of variable nodes in a factor graph, each variable node having a variable defined as a frequency band state of each modeled base station.

Step 304: Model the plurality of wireless devices as a plurality of constraint nodes in the factor graph, each constraint node linked to the variable nodes that the corresponding base stations have radio ranges covering the modeled wireless device, and having a constraint defined as that frequency band states of the base stations with the radio range covering the modeled wireless devices cannot be all turned off.

Step 306: Select a base station for transmission from the plurality of base stations based on the factor graph.

Step 308: End.

According to the process 30, the embodiment of the present invention models the base stations with the overlapped radio ranges and the wireless devices in the wireless communication system as the variable nodes and the constraint nodes in the factor graph, respectively. Each of the variable nodes is defined as the frequency band state of each base station. Each of the constraint nodes is linked to the variable node that the corresponding base stations have the radio ranges covering the modeled wireless device. The constraint of the constraint node is defined as that the frequency band states of the base stations with the radio ranges covering the wireless devices can not be all turned off. Consequently, the embodiment of the present invention can use the factor graph, which has the distributed computing property in nature, to model the overlapped base station problem in the multicast scenario, so as to effectively select base stations for multicast transmission on different network topologies. Further, since the constraint is only associated with the variable nodes connected with the constraint nodes, the embodiment of the present invention can perform the distributed computation between the wireless devices and the base stations, and significantly reduce the computation complexity.

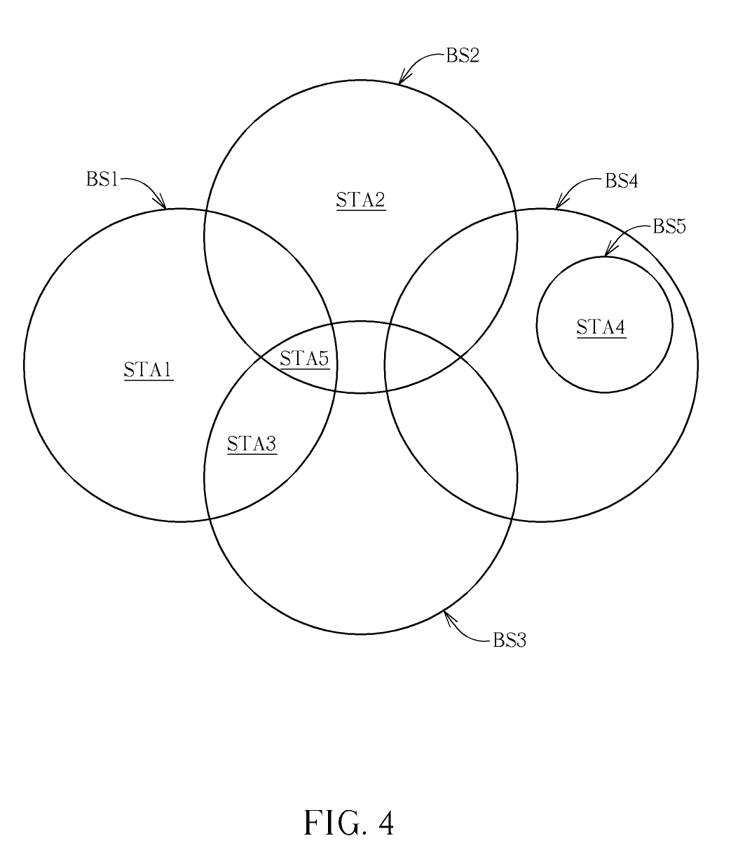

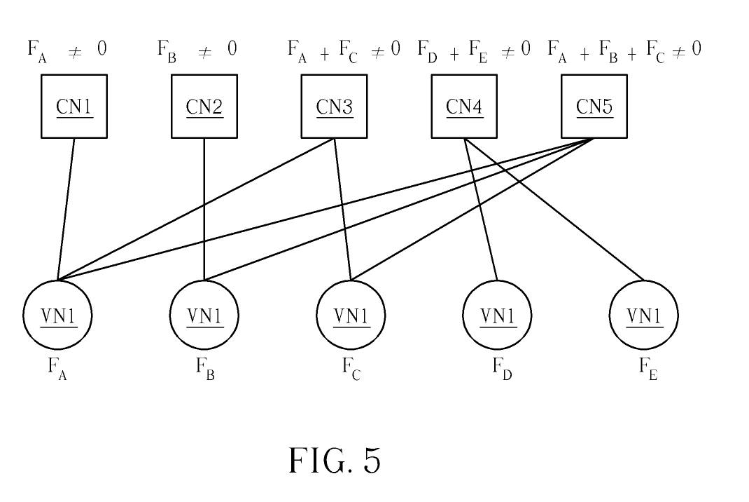

For example, please refer to FIG. 4, which is a schematic diagram of a wireless communication system 40 with the overlapping base station problem. As shown in FIG. 4, the wireless communication system 40 includes base stations BS1˜BS5 with overlapped radio ranges, and wireless devices STA1˜STA5. Assume that the circles represent the variable nodes and the rectangles represent the constraint nodes, a factor graph, which is generated by modeling the network topology in FIG. 4 according to the embodiment of the present invention is illustrated as FIG. 5. In FIG. 5, variable nodes VN1˜VN5 correspond to the base stations BS1˜BS5 and represent frequency band states F_{A}˜F_{E} being assigned to each base station, respectively. Constraint nodes CN1˜CN5 correspond to the wireless devices STA1˜STA5, and are connected to the variable nodes that the corresponding base stations have radio ranges covering the modeled wireless device. The constraint nodes CN1˜CN5 are utilized for representing the constraints that the frequency band states of the base stations with the radio ranges covering the modeled wireless device can not be all turned off.

For example, the wireless device STA5 is located within the radio ranges of the base stations BS1, BS2 and BS3. Thus, the constraint node CN5 corresponding to the wireless device STA5 needs to be connected to the variable nodes VN1, VN2, and VN3 which correspond to the base stations BS1, BS2 and BS3, respectively. In addition, since at least one of the base stations BS1, BS2, and BS3 is needed to transmit multicast data to the wireless device STA5, the frequency bands of the base stations BS1, BS2 and BS3 can not be all turned off. Similarly, the wireless device STA4 is located within the radio ranges of the base stations BS4 and BS5. Thus, the constraint node CN4 corresponding to the wireless device STA4 needs to be connected to the variable nodes VN4 and VN5 which correspond to base stations BS4 and BS5, respectively. And the frequency bands of the base stations BS4 and BS5 can not be all turned off.

Preferably, the frequency band states F_{A}˜F_{E} of each base station can be represented by a number “0” or “1”. The number “0” represents that the frequency band of the base station is turned off, and the number “1” represents that the frequency band of the base station is turned on. In this situation, the embodiment of the present invention can use a logic function to represent the constraint of each constraint node. For example, the constraints of the constraint nodes CN4 and CN5 can be represented as follows: F_{A}+F_{B}+F_{C}≠0 and F_{D}+F_{E}≠0. The other constraint nodes can be derived by the same token.

After each node has been defined in the factor graph, the soft information is transmitted back and forth between the variable nodes and the constraint nodes by the following steps to determine the frequency band state of each base station: Step 1: Initialize the variable nodes; Step 2: Transmit the soft information from the variable nodes to the constraint nodes; Step 3: Transmit the soft information from the constraint nodes back to the variable nodes; Step 4: Stop transmitting the soft information according to a predetermined stopping criterion and make a hard decision. After the hard decision, the frequency band state of each base station can be determined according to negotiation results of the variable nodes and the constraint nodes, so as to select the base station for multicast transmission. The aforementioned factor graph operations are well known by those skilled in the art, and therefore not detailed here.

Further, the embodiment of the present invention can enhance operational efficiency by weighting the constraints. For example, when one base station is located within the overlapped radio range formed by two base stations, in contrast to the situation that the frequency band states of both base stations are turned on, another possible situation that only one base station is turned on is set to a higher weighting value, to increase the efficiency for determining the frequency band states of the base stations. Such variation is also included in the scope of the present invention.

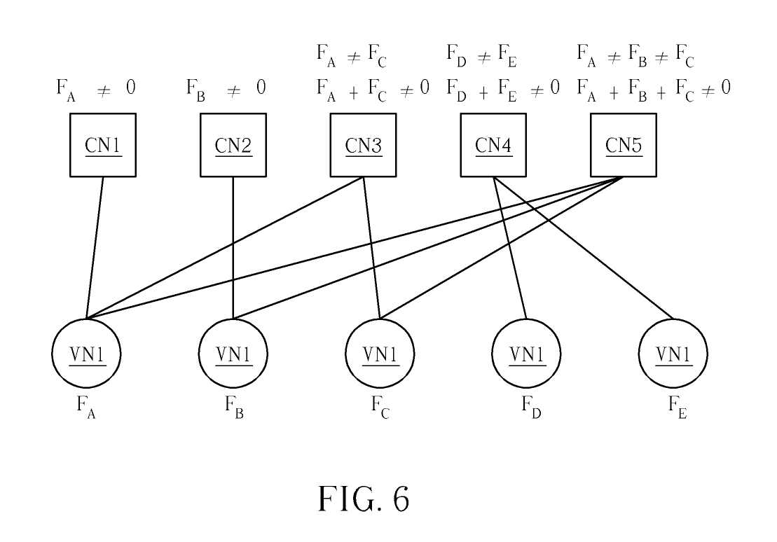

Generally speaking, after the base station for the multicast transmission has been selected, the wireless communication system further needs to assign different frequency bands to the adjacent base stations with the overlapped radio range, to avoid data collision due to the hidden terminal problem. In this situation, the present invention can combine the frequency band assignment problem with the aforementioned base station selection problem by use of the factor graph. For example, please refer to FIG. 6, which is a factor graph generated by modeling the network topology in FIG. 4 according to another embodiment of the present invention. In this embodiment of the present invention, the constraint of the constraint nodes not only represents that base stations with the radio ranges covering the modeled wireless device can not be all turned off, but also represents the frequency bands of the base stations with the radio ranges covering the modeled wireless device must be assigned to the different frequency bands. Take the constrain node CN5 as an example, since the wireless device STA5 is within the overlapped radio range formed by the base stations BS1, BS2 and BS3, the frequency bands of the base stations BS1, BS2 and BS3 can neither be all turned off, nor be assigned to the same frequency band, to avoid data collision over transmission. Therefore, the constraint of the constraint node CN5 can be represented by the following equations: F_{A}+F_{B}+F_{c}≠0 and F_{A}≠F_{B}≠F_{C}. In this situation, each variable node not only uses “0” to represent that the frequency band of the base station is turned off but also uses “1˜N” to represent available frequency bands for the base station. The other constraint nodes can be derived by the same token.

Consequently, the embodiment of the present invention not only selects the base station for multicast transmission but also simultaneously determines the frequency band for the base station, to avoid data collision due to the hidden terminal problem.

As for hardware implementation, the meanings of the base stations and wireless devices can be defined according to requirements of different wireless communication system. For a WLAN, the base station is defined as an access point and the wireless device could represent a device equipped with a wireless adapter, such as a laptop or related network equipments.

To sum up, the present invention uses the distributed computing property of the factor graph to model the overlapping base station problem in the multicast scenario based on the distributed property of the network, such that the base station for multicast transmission can be effectively selected for all kinds of network topologies, and thereby the disadvantages in the prior art are improved.

Those skilled in the art will readily observe that numerous modifications and alterations of the device and method may be made while retaining the teachings of the invention.

What is claimed is:

1. A base station selection method for a wireless communication system, the wireless communication system comprising a plurality of base stations with overlapped radio ranges and a plurality of wireless devices, the method comprising the steps of:
modeling the plurality of base stations as a plurality of variable nodes in a factor graph, each variable node having a variable defined as a frequency band state of the modeled base station;
modeling the plurality of wireless devices as a plurality of constraint nodes in the factor graph, each constraint node linked to the variable nodes that the corresponding base stations have radio ranges covering the modeled wireless device, and having a constraint defined as that frequency band states of the base stations with the radio ranges covering the modeled wireless devices cannot be all turned off; and
selecting a base station for transmission from the plurality of base stations based on the factor graph.

2. The base station selection method of claim 1, wherein the variable of each variable node is further defined as a frequency band of each base station.

3. The base station selection method of claim 2, wherein the constraint of each constraint node is further defined as that frequency bands of the base stations with the radio ranges covering the modeled wireless devices must be assigned to different frequency bands.

4. The base station selection method of claim 1, wherein the step of selecting a base station for transmission from the plurality of base stations based on the factor graph comprises the steps of:
initializing the plurality of variable nodes;
transmitting soft information associated with the frequency band states back and forth between the mutually connected variable nodes and constraint nodes;
stopping transmitting the soft information according to a predetermined stopping criterion and making a hard decision to determine the frequency band states of the plurality of base stations.

5. The base station selection method of claim 1 further comprising the step of:
using a weighted method to change the constraints of the plurality of constraint nodes.

6. The base station selection method of claim 1, wherein the plurality of base stations are operated in a multicast mode.

7. The base station selection method of claim 1, wherein the wireless communication system is a wireless local network system (WLAN).

8. A wireless device for a wireless communication system, the wireless device executing the said method of claim 1, to select base stations for transmission over the wireless communication system.
